(19) United States
(12) Patent Application Publication
(10) Pub. No.: US 2015/0163435 A1
(43) Pub. Date: Jun. 11, 2015

(54) DEVICE, IMAGE SENSOR, METHOD FOR DRIVING DEVICE, AND METHOD FOR DRIVING IMAGE SENSOR

(71) Applicant: CANON KABUSHIKI KAISHA, Tokyo (JP)

(72) Inventor: Keisuke Ota, Tokyo (JP)

(21) Appl. No.: 14/562,558

(22) Filed: Dec. 5, 2014

(30) Foreign Application Priority Data
Dec. 11, 2013 (JP) 2013-255672

(51) Int. Cl. H04N 5/378; H04N 5/357; H04N 5/374; H04N 5/376

(52) U.S. Cl. CPC H04N 5/378; H04N 5/3765; H04N 5/357; H04N 5/3742

(57) ABSTRACT

There are provided an image sensor and an image capturing device that detect the cycle of cyclic noise produced by an external circuit outside the image sensor and set operation timings of the image sensor on the basis of the detected cycle.

### BACKGROUND OF THE INVENTION

1. Field of the Invention

The present invention relates to a device, an image sensor, a method for driving a device, and a method for driving an image sensor.

2. Description of the Related Art

There has been an image sensor that includes pixels which generate photoelectric conversion signals based on incident light and a signal processor which samples the photoelectric conversion signals and noise signals occurring in the pixels. The signal processor subtracts a noise signal from a photoelectric conversion signal, so that the image sensor is able to output an image capturing signal with a reduced noise component from the photoelectric conversion signal. As a noise component included in the photoelectric conversion signal is closer to the signal level of the noise signal, the signal processor is able to output an image capturing signal from the photoelectric conversion signal with the noise component being reduced with higher accuracy.

In the first invention described in Japanese Patent Laid-Open No. 2010-50636, the driving frequency F of a focus driving actuator of a lens mounted on a camera that has an image sensor is read from information about the driving frequency F of the focus driving actuator, the information being stored in advance for the lens. On the basis of the information about the driving frequency F that has been read, respective timings are set at which a signal processor retains a photoelectric conversion signal and a noise signal. As a result, cyclic noise produced by the focus driving actuator of the lens is included in a photoelectric conversion signal to a similar extent as a noise signal. Accordingly, when the signal processor subtracts the noise signal from the photoelectric conversion signal, the image sensor is able to output an image capturing signal with the cyclic noise produced by the focus driving actuator of the lens being reduced.

In the second invention described in Japanese Patent Laid-Open No. 2010-50636, the driving frequency F of the focus driving actuator of the lens is changed on the basis of respective timings when the signal processor retains a photoelectric conversion signal and a noise signal.

### SUMMARY OF THE INVENTION

An aspect of the present invention is a device including an image sensor, a detector, and a controller. The image sensor includes a pixel configured to generate a photoelectric conversion signal by performing photoelectric conversion based on an incident light, and a signal processor configured to sample the photoelectric conversion signal and a noise signal occurring in the pixel. The detector is configured to detect a cycle of cyclic noise produced by an operation of an external circuit. The controller is configured to set timings when the signal processor samples the photoelectric conversion signal and the noise signal, based on the detected cycle.

Another aspect of the present invention is a device including an image sensor, a detector, and a controller. The image sensor includes a pixel configured to generate a photoelectric conversion signal by performing photoelectric conversion based on an incident light, and a signal processor configured to sample the photoelectric conversion signal and a noise signal occurring in the pixel. The detector is configured to detect a cycle of cyclic noise produced by an operation of an external circuit. The controller is configured to control a driving frequency of the external circuit so as to make the detected cycle of the cyclic noise have a length of A/p times a time difference A between a timing when the signal processor retains the noise signal and a timing when the signal processor retains the photoelectric conversion signal, p being a natural number.

Another aspect of the present invention is a device including an image sensor, a detector, and a controller. The image sensor includes a pixel configured to generate a photoelectric conversion signal by performing photoelectric conversion based on an incident light, an analog-digital converter configured to perform analog-digital conversion on the photoelectric conversion signal and a noise signal occurring in the pixel, and a reference signal supply unit configured to supply a first reference signal used in analog-digital conversion on the noise signal and a second reference signal used in analog-digital conversion on the photoelectric conversion signal. The detector is configured to detect a cycle of cyclic noise produced by an operation of an external circuit. The controller is configured to set a timing when an initial value of the first reference signal is determined and a timing when an initial value of the second reference signal is determined, based on the detected cycle of the cyclic noise.

Another aspect of the present invention is an image sensor including a pixel, a signal processor, a detector, and a controller. The pixel is configured to generate a photoelectric conversion signal by performing photoelectric conversion based on an incident light. The signal processor is configured to sample the photoelectric conversion signal and a noise signal occurring in the pixel. The detector is configured to detect a cycle of cyclic noise produced by an operation of an external circuit. The controller is configured to set timings when the signal processor samples the photoelectric conversion signal and the noise signal, based on the detected cycle.

Another aspect of the present invention is a method for driving a device that includes an image sensor, the image sensor including a pixel that generates a photoelectric conversion signal by performing photoelectric conversion based on an incident light and a signal processor that samples the photoelectric conversion signal and a noise signal occurring in the pixel. The method includes detecting a cycle of cyclic noise produced by an operation of an external circuit, and setting timings when the signal processor samples the photoelectric conversion signal and the noise signal, based on the detected cycle of the cyclic noise.

Another aspect of the present invention is a method for driving an image sensor including a pixel that generates a photoelectric conversion signal by performing photoelectric conversion based on an incident light and a signal processor that samples the photoelectric conversion signal and a noise signal occurring in the pixel. The method includes detecting a cycle of cyclic noise produced by an operation of an external circuit, and setting timings when the signal processor samples the photoelectric conversion signal and the noise signal, based on the detected cycle of the cyclic noise.

Further features of the present invention will become apparent from the following description of exemplary embodiments with reference to the attached drawings.

### BRIEF DESCRIPTION OF THE DRAWINGS

FIG. 1 is a diagram illustrating an example of a configuration of an image capturing device.

FIG. 2 is a diagram illustrating an example of a configuration of an image sensor.

FIG. 3A is a diagram illustrating an example of a configuration of a pixel, and FIG. 3B is a diagram illustrating an example of a configuration of a noise detector.

FIG. 4 is a diagram illustrating an example of operations in the image capturing device.

FIG. 5 includes diagrams illustrating examples of a relation between cyclic noise and operations in the image capturing device.

FIG. 6 is a diagram illustrating another example of a configuration of the image sensor.

FIG. 7 is a diagram illustrating an example of a configuration of a ramp signal supply unit.

FIG. 8 is a diagram illustrating another example of operations in the image capturing device.

FIG. 9 is a diagram illustrating an example of a relation between cyclic noise and operations in the image capturing device.

### DESCRIPTION OF THE EMBODIMENTS

In the first invention described in Japanese Patent Laid-Open No. 2010-50636, the driving frequency F is handled while being assumed to be a fixed frequency. However, the driving frequency F varies depending on the temperature and a manufacturing variation in the focus driving actuator. Therefore, the amount of cyclic noise included in a photoelectric conversion signal may be different from that included in a noise signal.

In the second invention described in Japanese Patent Laid-Open No. 2010-50636, even if an instruction is given to the focus driving actuator for changing the driving frequency F, the resulted driving frequency may shift from a desired driving frequency F due to the temperature and a manufacturing variation in the focus driving actuator. Also in this case, the amount of cyclic noise included in a photoelectric conversion signal may be different from that included in a noise signal.

Accordingly, in the image capturing device described in Japanese Patent Laid-Open No. 2010-50636, even if a noise signal is subtracted from a photoelectric conversion signal, cyclic noise might not be subtracted with high accuracy.

A technique for addressing the above-described issue will be described below.

Exemplary embodiments will be described below with reference to the drawings.

### First Exemplary Embodiment

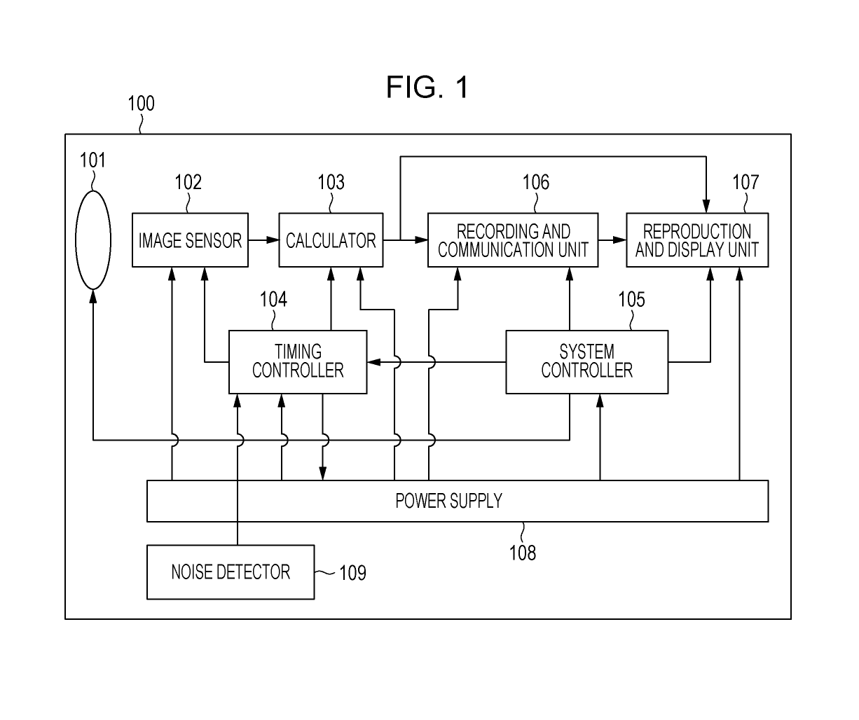

FIG. 1 is a block diagram illustrating a configuration of an image capturing device according to this exemplary embodiment. An image capturing device 100 includes an optical system 101 that guides incident light to an image sensor 102, the image sensor 102 that generates an image capturing signal based on the incident light, and a calculator 103 that generates an image using the image capturing signal output by the image sensor 102. The image capturing device 100 further includes a timing controller 104 that generates timings for controlling driving of the image sensor 102 and the calculator 103 and for controlling the switching frequency of a power supply 108. The image capturing device 100 further includes a recording and communication unit 106 that records the image generated by the calculator 103, and that functions as a communication system which processes input from an external device or a user, and a reproduction and display unit 107 that displays the image and a menu setting screen. The image capturing device 100 further includes a system controller 105 including a central processing unit (CPU) which controls the entire system, and the power supply 108 which supplies power to each unit. The image capturing device 100 further includes a noise detector 109 that detects the cycle of noise produced by operations of the power supply 108.

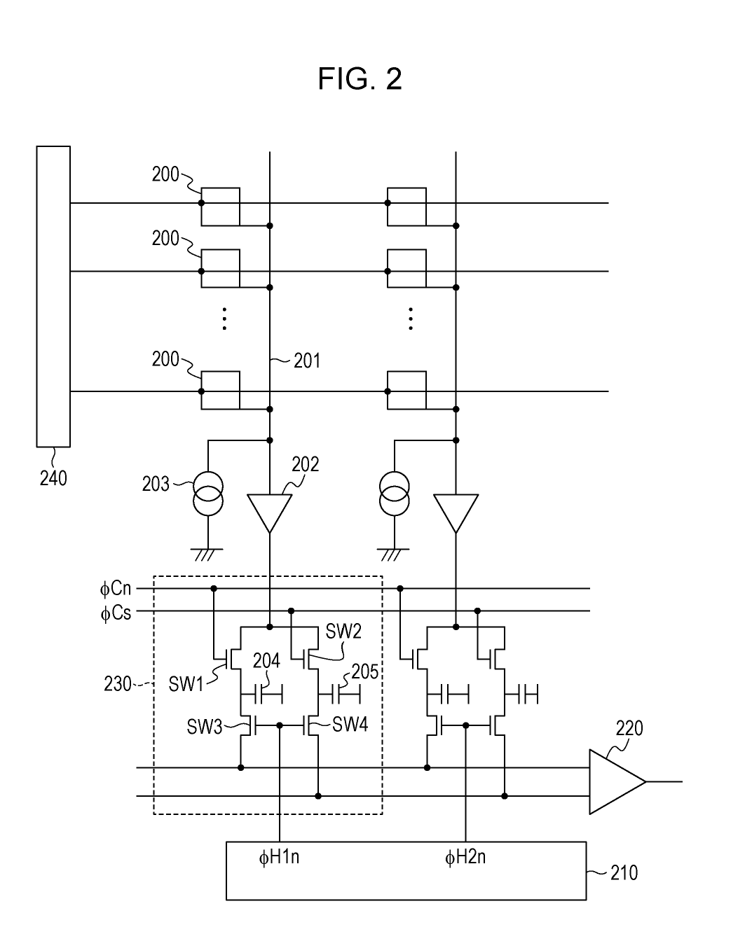

FIG. 2 is a diagram illustrating an example of a configuration of the image sensor 102 in FIG. 1.

The image sensor 102 includes pixels 200 that are provided in a matrix form. In FIG. 2, the pixels 200 in two columns are illustrated, and members relating to the pixels 200 in one column are given reference numerals. Members relating to the adjacent pixels 200 are similar to those relating to the pixels 200 in the one column. Hereinafter, a configuration relating to the pixels 200 in the one column with reference numerals will be focused and described.

The pixel 200 outputs a noise signal and a photoelectric conversion signal based on incident light to an amplifier 202 via a vertical signal line 201. A current source 203 supplies a current to the pixels 200 via the vertical signal line 201.

A signal processor 230 includes a capacitor element 204, a capacitor element 205, a switch SW1, a switch SW2, a switch SW3, and a switch SW4. A timing generator, which is not illustrated, supplies a signal φCn to the control node of the switch SW1. The timing generator, which is not illustrated, supplies a signal φCs to the control node of the switch SW2. A horizontal scan unit 210 supplies a signal φH1n to the control node of the switch SW3 and the control node of the switch SW4. The horizontal scan unit 210 supplies a signal φH2n to the switch SW3 and the switch SW4 in the column adjacent to the column to which the horizontal scan unit 210 supplies the signal φH1n.

To an output amplifier 220, the capacitor element 204 is electrically connected via the switch SW3, and the capacitor element 205 is electrically connected via the switch SW4. The output amplifier 220 outputs, to the outside of the image sensor 102, a signal obtained by amplifying a signal that is a difference between a signal input from the capacitor element 204 and a signal input from the capacitor element 205.

A vertical scan unit 240 controls operations of the pixels 200 on a row-by-row basis.

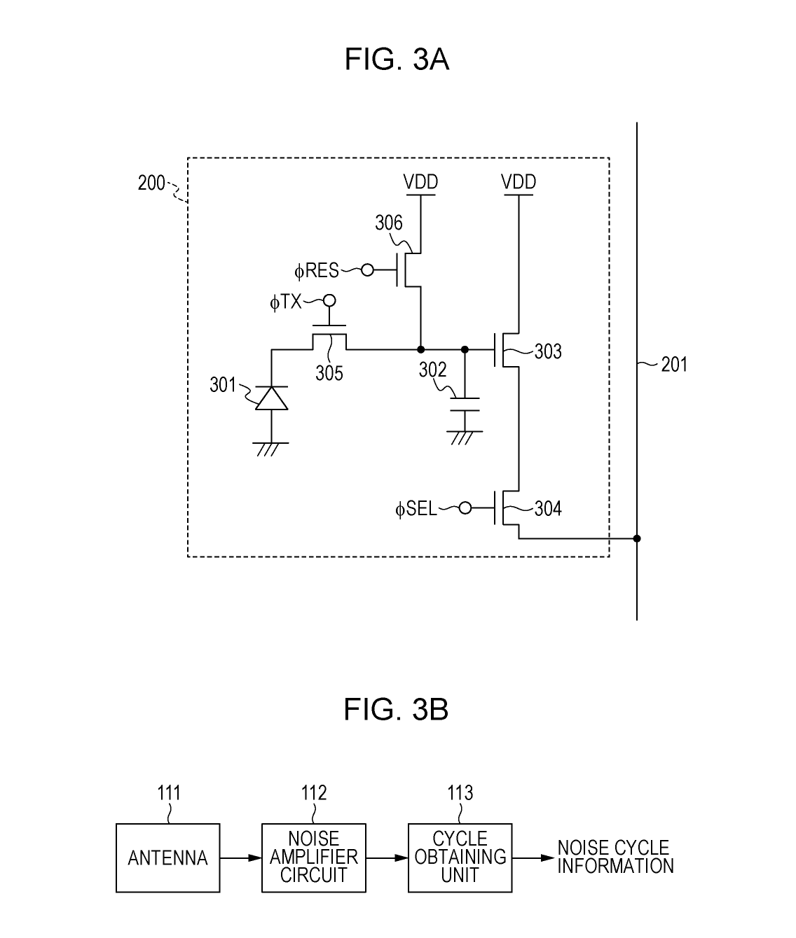

FIG. 3A is a diagram illustrating a configuration of the pixel 200. A photoelectric converter 301 accumulates charge based on incident light. A floating diffusion capacitor 302 is electrically connected to the photoelectric converter 301 via a transistor 305. The input node of a transistor 303 is electrically connected to the floating diffusion capacitor 302. One main node of the transistor 303 is electrically connected to one main node of a transistor 304. To the other main node of the transistor 303, a power supply voltage VDD is supplied. The other main node of the transistor 304 is electrically connected to the vertical signal line 201. To one main node of a transistor 306, the power supply voltage VDD is supplied. The other main node of the transistor 306 is electrically connected to the floating diffusion capacitor 302. The vertical scan unit 240 illustrated in FIG. 2 supplies a signal φTX to the control node of the transistor 305. The vertical scan unit 240 supplies a signal φSEL to the control node of the transistor 304. The vertical scan unit 240 supplies a signal φRES to the control node of the transistor 306.

FIG. 3B is a diagram illustrating a configuration of the noise detector 109. The noise detector 109 includes an antenna 111, a noise amplifier circuit 112, and a cycle obtaining unit 113. The antenna 111 receives noise and outputs the received noise to the noise amplifier circuit 112. In this exemplary embodiment, a minute loop antenna is used as the antenna 111. The cycle obtaining unit 113 includes a unit that converts an analog signal into a digital signal, and converts the digital signal into cycle information by performing Fourier transform. The cycle obtaining unit 113 analyzes the cycle information obtained as a result of conversion, and identifies cyclic noise that is most commonly included in signals retained by the capacitor element 204 and the capacitor element 205. The cycle obtaining unit 113 outputs the cycle of the cyclic noise that has been obtained to the timing controller 104 illustrated in FIG. 1, as noise cycle information.

Noise frequency information obtained as a result of conversion into a frequency is transmitted to the timing controller 104.

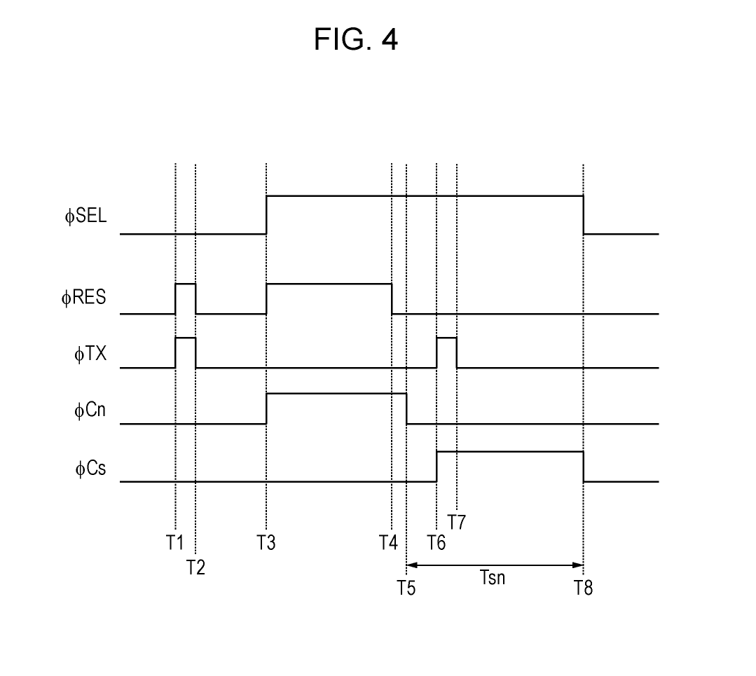

FIG. 4 is a diagram illustrating operations in the image sensor 102 in FIG. 2. At a time T1, the vertical scan unit 240 sets the signal φRES and the signal φTX to a high level (hereinafter represented as “H level”). As a result, charge in the photoelectric converter 301 and the floating diffusion capacitor 302 is reset. At the time T1, the vertical scan unit 240 keeps the signal φSEL at a low level (hereinafter represented as “L level”). The timing generator, which is not illustrated, keeps both of the signal φCn and the signal φCs at the L level.

At a time T2, the vertical scan unit 240 sets the signal φRES and the signal φTX to the L level. The timing generator keeps the signal φCn and the signal φCs at the L level at the time T2.

At a time T3, the vertical scan unit 240 sets the signal φRES to the H level. As a result, charge in the floating diffusion capacitor 302 is reset in the pixel 200. The vertical scan unit 240 sets the signal φSEL to the H level. As a result, the transistor 303 outputs a signal based on the potential of the floating diffusion capacitor 302 which has been reset, to the vertical signal line 201 via the transistor 304. At the time 3, the timing generator sets the signal φCn to the H level. As a result, a signal output by the amplifier 202 is input to the capacitor element 204.

At a time T4, the vertical scan unit 240 sets the signal φRES to the L level. As a result, reset of the floating diffusion capacitor 302 is cancelled. A signal output by the transistor 303 from the time T4 is a noise signal (hereinafter represented as “N signal”). The amplifier 202 outputs a signal obtained by amplifying the N signal (hereinafter represented as “amplified N signal”).

At a time T5, the timing generator sets the signal φCn to the L level. At this time, the capacitor element 204 retains the amplified N signal input from the amplifier 202.

At a time T6, the vertical scan unit 240 sets the signal φTX to the H level. As a result, charge accumulated by the photoelectric converter 301 is input to the floating diffusion capacitor 302 via the transistor 305. The timing generator sets the signal φCs to the H level. As a result, a signal output by the amplifier 202 is input to the capacitor element 205.

At a time T7, the vertical scan unit 240 sets the signal φTX to the L level. As a result, input of charge from the photoelectric converter 301 to the floating diffusion capacitor 302 ends. A signal output by the transistor 303 from the time T7 is a photoelectric conversion signal (hereinafter represented as “S signal”). The amplifier 202 outputs a signal obtained by amplifying the S signal (hereinafter represented as “amplified S signal”).

At a time T8, the timing generator sets the signal φCs to the L level. At this time, the capacitor element 205 retains the amplified S signal input from the amplifier 202.

In a period after the time T8, the horizontal scan unit 210 sets the signal φH1n and the signal φH2n to the H level sequentially. As a result, the amplified N signal and the amplified S signal respectively retained by the capacitor element 204 and the capacitor element 205 in each column are sequentially output to the output amplifier 220.

A period Tsn is a time difference between a timing when the amplified N signal is retained and a timing when the amplified S signal is retained.

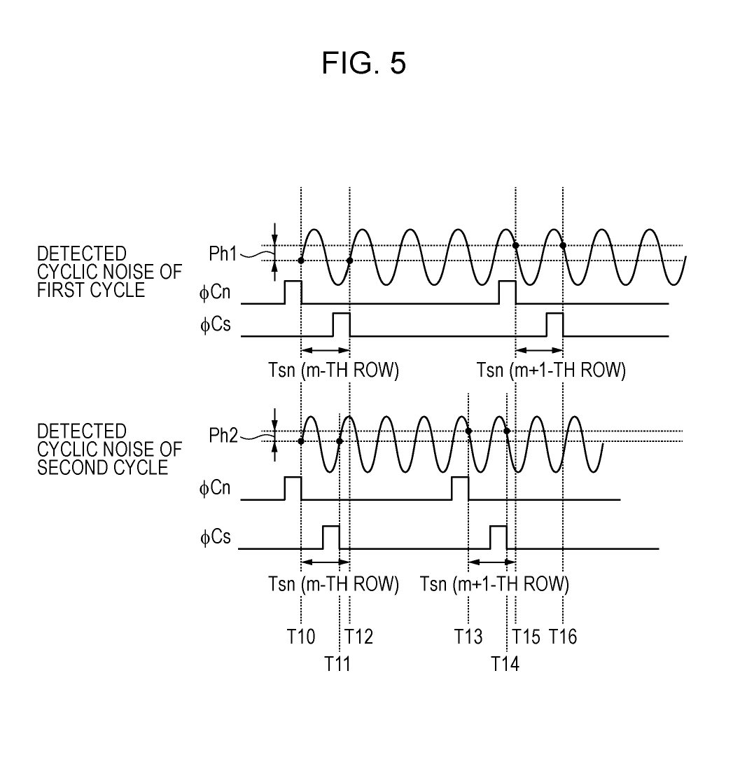

FIG. 5 is a diagram illustrating cyclic noise detected by the noise detector 109, the signal φCn, and the signal φCs. The power supply 108 includes a DC-DC converter that generates a power supply voltage. In the image capturing device 100 of this exemplary embodiment, cyclic noise illustrated in FIG. 5 is produced by switching operations of the DC-DC converter. The period Tsn illustrated in FIG. 5 is the period Tsn illustrated in FIG. 4.

First, a case where the noise detector 109 detects cyclic noise of the first cycle as illustrated in FIG. 5 will be described. The timing controller 104 illustrated in FIG. 1 outputs, to the timing generator of the image sensor 102, configuration information about timings when the signal φCn and the signal φCs are set to the L level from the H level, on the basis of noise cycle information input from the noise detector 109. The timing controller 104 outputs, to the timing generator of the image sensor 102, configuration information specifying that a time when the signal φCn is set to the L level from the H level is set to a time T10, this signal φCn making the capacitor element 204 retain the amplified N signal corresponding to the pixel 200 in the m-th (m is a natural number) row. The timing controller 104 outputs, to the timing generator of the image sensor 102, configuration information specifying that a time when the signal φCs is set to the L level from the H level is set to a time T12, this signal φCs making the capacitor element 205 retain the amplified S signal corresponding to the pixel 200 in the m-th row. The timing controller 104 outputs, to the timing generator of the image sensor 102, configuration information specifying that a time when the signal φCn is set to the L level from the H level is set to a time T15, this signal φCn making the capacitor element 204 retain the amplified N signal corresponding to the pixel 200 in the m+1-th row. The timing controller 104 outputs, to the timing generator of the image sensor 102, configuration information specifying that a time when the signal φCs is set to the L level from the H level is set to a time T16, this signal φCs making the capacitor element 205 retain the amplified S signal corresponding to the pixel 200 in the m+1-th row.

On the amplified N signal and the amplified S signal corresponding to the pixel 200 in the m-th row, cyclic noise having the same phase is superimposed. Therefore, by subtracting the amplified N signal from the amplified S signal, it is possible to generate an image capturing signal from which a noise component caused by the cyclic noise of the first cycle has been subtracted. Also on the amplified N signal and the amplified S signal corresponding to the pixel 200 in the m+1-th row, cyclic noise having the same phase is superimposed. The phase of the cyclic noise of the first cycle that is superimposed on the amplified N signal and the amplified S signal in a case of the m-th row shifts by Ph1 from that in a case of the m+1-th row. However, by subtracting the amplified N signal from the amplified S signal, the amplified N signal and the amplified S signal corresponding to the pixel 200 in the m+1-th row, it is possible to generate an image capturing signal from which the noise component caused by the cyclic noise of the first cycle has been subtracted. That is, it is sufficient that the phase of the cyclic noise of the first cycle that is superimposed on the amplified N signal corresponding to the pixel 200 in a row is aligned with the phase of the cyclic noise of the first cycle that is superimposed on the amplified S signal corresponding to the pixel 200 in the same row. As a result, by subtracting the amplified N signal from the amplified S signal, it is possible to generate an image capturing signal from which the noise component caused by the cyclic noise of the first cycle has been subtracted.

Next, a case will be described where the noise detector 109 detects cyclic noise of the second cycle that is shorter than the first cycle.

The timing controller 104 outputs, to the timing generator of the image sensor 102, configuration information specifying that a time when the signal φCn is set to the L level from the H level is set to the time T10, this signal φCn making the capacitor element 204 retain the amplified N signal corresponding to the pixel 200 in the m-th (m is a natural number) row. The timing controller 104 outputs, to the timing generator of the image sensor 102, configuration information specifying that a time when the signal φCs is set to the L level from the H level is set to a time T11, this signal φCs making the capacitor element 205 retain the amplified S signal corresponding to the pixel 200 in the m-th row. The timing controller 104 outputs, to the timing generator of the image sensor 102, configuration information specifying that a time when the signal φCn is set to the L level from the H level is set to a time T13, this signal φCn making the capacitor element 204 retain the amplified N signal corresponding to the pixel 200 in the m+1-th row. The timing controller 104 outputs, to the timing generator of the image sensor 102, configuration information specifying that a time when the signal φCs is set to the L level from the H level is set to a time T14, this signal φCs making the capacitor element 205 retain the amplified S signal corresponding to the pixel 200 in the m+1-th row.

The phase of the cyclic noise of the second cycle that is superimposed on the amplified N signal and the amplified S signal in the case of the m-th row shifts by Ph2 from that in the case of the m+1-th row. However, in the image capturing device 100 according to this exemplary embodiment, it is sufficient that the phase of the cyclic noise of the second cycle that is superimposed on the amplified N signal corresponding to the pixel 200 in a row is aligned with the phase of the cyclic noise of the second cycle that is superimposed on the amplified S signal corresponding to the pixel 200 in the same row. As a result, by subtracting the amplified N signal from the amplified S signal, it is possible to generate an image capturing signal from which a noise component caused by the cyclic noise of the second cycle has been subtracted.

As described above, the timing controller 104 of this exemplary embodiment sets respective times when the signal φCn and the signal φCs are set to the L level from the H level, on the basis of the cycle of cyclic noise detected by the noise detector 109. As a result, even if the cycle of noise produced by the DC-DC converter of the power supply 108 varies due to the temperature of and a manufacturing variation in the image capturing device 100, it is possible to superimpose cyclic noise having the same phase on the amplified S signal and the amplified N signal. Accordingly, by subtracting the amplified N signal from the amplified S signal, it is possible to obtain an image capturing signal in which the noise produced by the DC-DC converter of the power supply 108 is reduced.

In this exemplary embodiment, an example has been described in which the noise detector 109 detects the cycle of noise produced by the DC-DC converter. As another example, the noise detector 109 may detect the cycle of cyclic noise that is produced by an element around the image sensor 102. Examples of such an element include an optical system drive circuit, such as an actuator that drives the optical system, an electronic flash charging circuit, and an anti-vibration circuit that performs image stabilization by moving the image sensor 102. Other examples of such an element include the calculator 103, the recording and communication unit 106, the reproduction and display unit 107, and the system controller 105.

While an example is assumed in this exemplary embodiment in which the period Tsn has a length equal to one cycle of the cyclic noise, this exemplary embodiment is not limited to the example. The period Tsn may have a length of n (n is a natural number) times the cycle T of the cyclic noise.

In this exemplary embodiment, an example has been described in which timings when the signal φCn and the signal φCs are set to the L level from the H level are controlled on the basis of the cycle of cyclic noise detected by the noise detector 109. As another example, the driving frequency of the source of cyclic noise may be changed on the basis of the cycle of the cyclic noise detected by the noise detector 109. For example, the source of cyclic noise may be the DC-DC converter. Even if the timing controller 104 performs control so as to make the DC-DC converter operate at a certain driving frequency, the actual driving frequency may differ from the driving frequency that has been set because of changes in the temperature and a manufacturing variation in the DC-DC converter. In this case, the timing controller 104 controls the driving frequency of the DC-DC converter on the basis of the cycle of cyclic noise detected by the noise detector 109 so that the cyclic noise has the same phase at a timing when the signal φCn is set to the L level from the H level and at a timing when the signal φCs is set to the L level from the H level. Specifically, the timing controller 104 controls the driving frequency of the DC-DC converter so that a period of one cycle, which is the inverse of the driving frequency of the DC-DC converter, is equal to Tsn/P, which is a value obtained by dividing the period Tsn by p (p is a natural number). As a result, by subtracting the amplified N signal from the amplified S signal, it is possible to generate an image capturing signal from which a noise component caused by the cyclic noise has been subtracted.

In this exemplary embodiment, a minute loop antenna is used as the antenna 111 of the noise detector 109. As another example, a loop-shaped pattern may be formed on a semiconductor substrate on which the image sensor 102 is provided, and this pattern may be used as the antenna 111. In this case, it is possible to detect cyclic noise that is received by the image sensor 102, with higher accuracy compared with a configuration in which the antenna 111 is provided outside the image sensor 102.

### Second Exemplary Embodiment

An image capturing device according to this exemplary embodiment will be described while focusing on differences from the first exemplary embodiment. The image capturing device according to this exemplary embodiment has the same configuration as in FIG. 1.

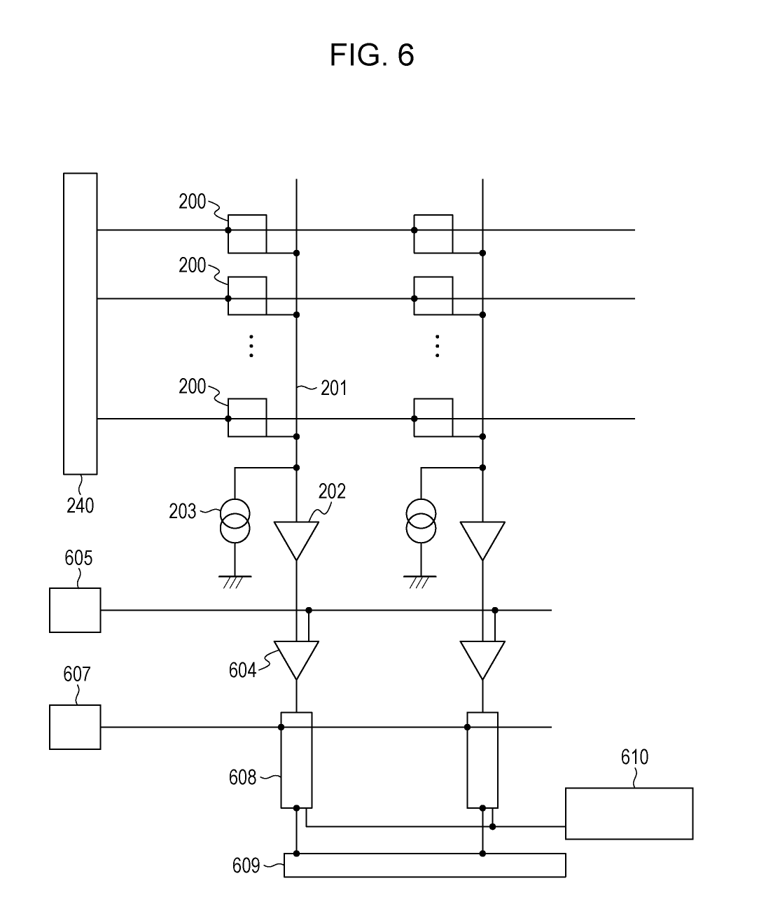

FIG. 6 is a diagram illustrating a configuration of the image sensor 102 included in the image capturing device of this exemplary embodiment. In FIG. 6, an element having the same function as an element included in the image sensor 102 illustrated in FIG. 2 is given the same reference numeral as in FIG. 2 and illustrated.

The image sensor 102 includes comparators 604, a ramp signal supply unit 605, a counter 607, storage units 608, a horizontal scan unit 609, and an output unit 610. An analog-digital (AD) converter in this exemplary embodiment includes the comparator 604 and the storage unit 608.

The ramp signal supply unit 605 is shared among and is connected to the plurality of comparators 604, and supplies ramp signals VRAMP. The ramp signal VRAMP is a signal having a potential that continuously changes as time passes. The ramp signal VRAMP is a reference signal that is used for the AD converter to perform AD conversion. The ramp signal supply unit 605 is a reference signal supply unit.

The comparator 604 is disposed in association with a corresponding column of the pixels 200.

The counter 607 is shared among and is connected to the storage units 608 in a plurality of rows.

The storage unit 608 is disposed in association with a corresponding column of the comparator 604.

The horizontal scan unit 609 scans the storage units 608 in respective columns to thereby make signals that have been retained in the storage units 608 in respective columns be sequentially output from the storage units 608 in respective columns to the output unit 610.

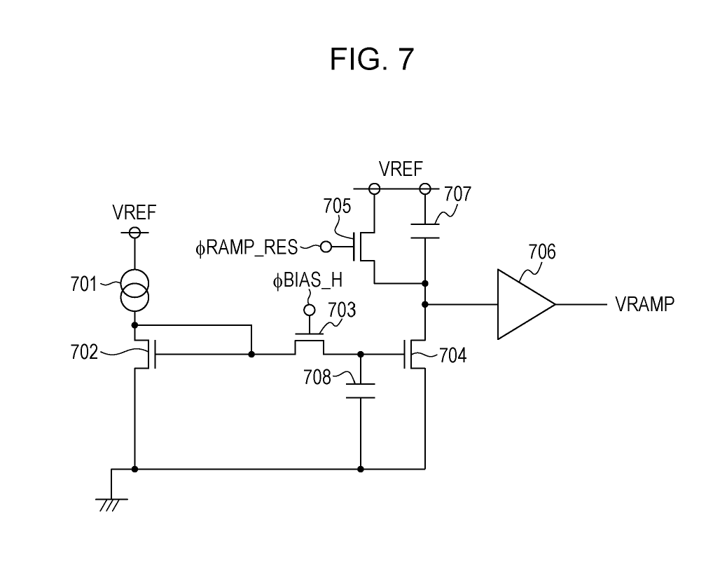

FIG. 7 is a diagram illustrating a configuration of the ramp signal supply unit 605.

The ramp signal supply unit 605 includes a current source 701, a transistor 702, a transistor 703, a transistor 704, a transistor 705, a capacitor element 707, a capacitor element 708, and a differential amplifier 706.

The ramp signal supply unit 605 includes a current mirror circuit formed of the current source 701 and the transistor 702. The current mirror circuit is electrically connected to one node of the capacitor element 708 and the input node of the transistor 704 via the transistor 703.

The other node of the capacitor element 708 is electrically connected to one main node of the transistor 702 and one main node of the transistor 704. The other main node of the transistor 704 is electrically connected to the input node of the differential amplifier 706, one main node of the transistor 705, and one node of the capacitor element 707. To the other main node of the transistor 705 and the other node of the capacitor element 707, a voltage VREF is supplied.

To the control node of the transistor 703, a signal φBIAS_H is supplied from the timing generator. To the transistor 705, a signal φRAMP_RES is supplied.

A signal output by the differential amplifier 706 is the ramp signal VRAMP output by the ramp signal supply unit 605.

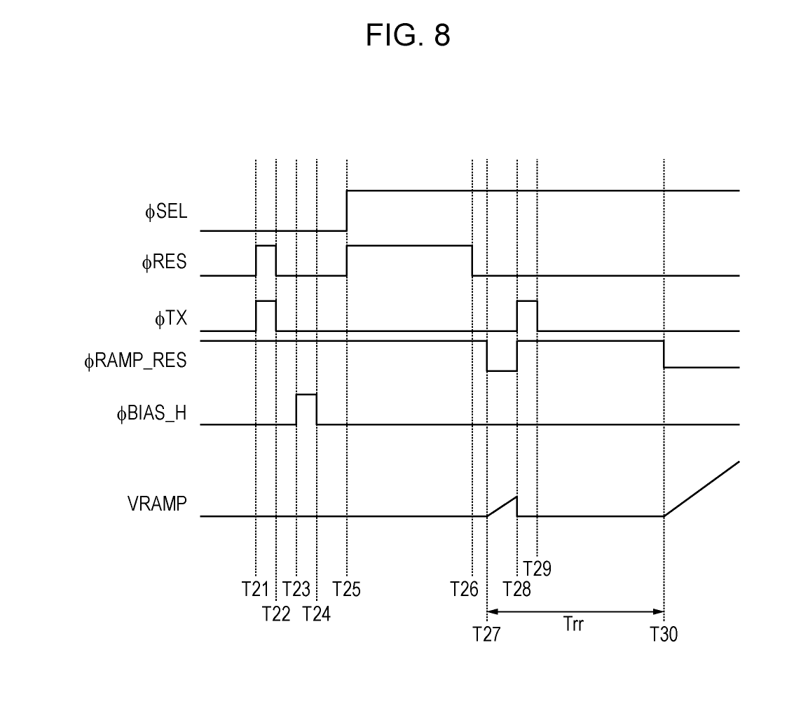

FIG. 8 is a diagram illustrating operations in the image capturing device according to this exemplary embodiment.

At a time T21, the vertical scan unit 240 sets the signal φRES and the signal φTX to the H level. As a result, reset of charge in the photoelectric converter (photodiode) 301 illustrated in FIG. 3A is started. At the time T21, the timing generator keeps the signal φRAMP_RES at the H level, and resets the ramp signal VRAMP.

At a time T22, the vertical scan unit 240 sets the signal φRES and the signal φTX to the L level. As a result, reset of charge in the photoelectric converter (photodiode) 301 is cancelled, and the photoelectric converter (photodiode) 301 starts accumulation of charge based on incident light.

At a time T23, the timing generator sets the signal φBIAS_H to the H level. At a time T24, the timing generator sets the signal φBIAS_H to the L level. As a result, the capacitor element 708 maintains a voltage output from the current mirror circuit that is formed of the current source 701 and the transistor 702.

At a time T25, the vertical scan unit 240 sets the signal φRES to the H level. As a result, reset of charge in the floating diffusion capacitor 302 illustrated in FIG. 3A is started. The vertical scan unit 240 sets the signal φSEL to the H level.

At a time T26, the vertical scan unit 240 sets the signal φRES to the L level. As a result, reset of charge in the floating diffusion capacitor 302 is cancelled. Consequently, the pixel 200 outputs the N signal to the amplifier 202 illustrated in FIG. 6. The amplifier 202 outputs the amplified N signal obtained by amplifying the N signal, to the comparator 604.

At a time T27, the timing generator sets the signal φRAMP_RES to the L level. As a result, the potential of the ramp signal VRAMP changes as time passes. This ramp signal VRAMP is the first reference signal used in AD conversion of the amplified N signal. The time T27 is a timing when the initial value of the first reference signal is determined. The counter 607 outputs a count signal obtained as a result of clock counting to the storage units 608 in respective columns. The comparator 604 outputs a comparison result signal that indicates the result of comparison between the potential of the amplified N signal output by the amplifier 202 and the potential of the ramp signal VRAMP, this potential changing in a time-dependent manner, to the storage unit 608. When the magnitude relation between the potential of the amplified N signal and the potential of the ramp signal VRAMP is reversed, the signal value of the comparison result signal changes. The storage unit 608 retains the count signal at a time when the signal value of the comparison result signal changes. The count signal retained by the storage unit 608 is a digital signal based on the amplified N signal.

At a time T28, the timing generator sets the signal φRAMP_RES to the H level. As a result, the potential of the ramp signal VRAMP is reset. The vertical scan unit 240 sets the signal φTX to the H level. As a result, charge accumulated by the photoelectric converter (photodiode) 301 illustrated in FIG. 3A is transferred to the floating diffusion capacitor 302 via the transistor 305.

At a time T29, the vertical scan unit 240 sets the signal φTX to the L level. As a result, transfer of charge accumulated by the photoelectric converter (photodiode) 301 to the floating diffusion capacitor 302 ends. The pixel 200 outputs the S signal to the amplifier 202. The amplifier 202 outputs the amplified S signal obtained by amplifying the S signal, to the comparator 604.

At a time T30, the timing generator sets the signal φRAMP_RES to the L level. As a result, the potential of the ramp signal VRAMP changes as time passes. This ramp signal VRAMP is the second reference signal used in AD conversion of the amplified S signal. The time T30 is a timing when the initial value of the second reference signal is determined. By the comparator 604, the counter 607, and the storage unit 608 performing operations similar to those on the amplified N signal described above, the storage unit 608 retains a digital signal based on the amplified S signal.

In FIG. 8, a period from the time T27 when the time generator sets the signal φRAMP_RES to the L level from the H level until the time T30 when the timing generator sets the signal φRAMP_RES to the L level from the H level again is represented as a period Trr.

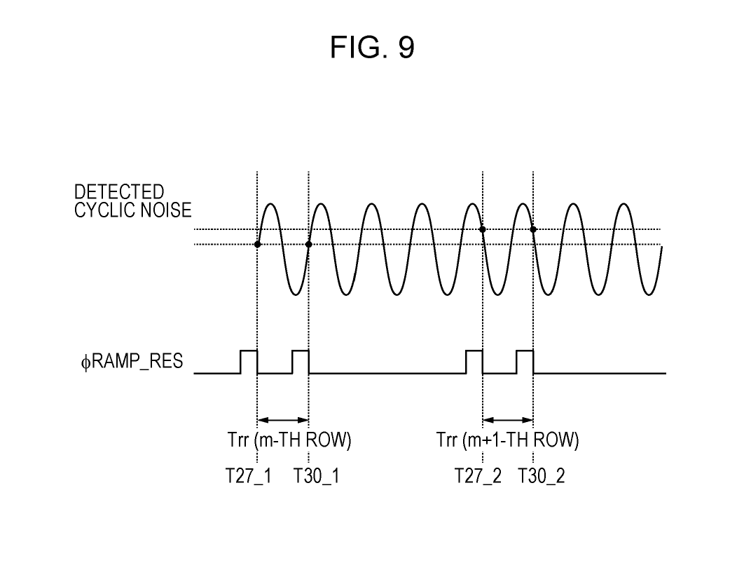

FIG. 9 is a diagram illustrating cyclic noise detected by the noise detector 109 illustrated in FIG. 1 and the signal φRAMP_RES. The cyclic noise illustrated in FIG. 9 is noise produced by switching operations of the DC-DC converter included in the power supply 108.

The period Trr illustrated in FIG. 9 is the period Trr illustrated in FIG. 8.

Cyclic noise may be superimposed on the voltage VREF that resets the capacitor element 707. In this case, if the phase of the cyclic noise at the time T27 in FIG. 8 differs from the phase of the cyclic noise at the time T30 in FIG. 8, the reset potential of the capacitor element 707 at the time T27 differs from that at the time T30. As a result, an offset occurs between the ramp signal VRAMP used in AD conversion of the amplified N signal and the ramp signal VRAMP used in AD conversion of the amplified S signal. A timing when the signal value of the comparison result signal of the comparator 604 changes differs depending on the offset. Consequently, the amount of a noise component caused by cyclic noise differs between a digital signal based on the amplified S signal and a digital signal based on the amplified N signal. Accordingly, in an image capturing signal obtained by subtracting the digital signal based on the amplified N signal from the digital signal based on the amplified S signal, a noise component caused by the cyclic noise still remains.

In the image capturing device according to this exemplary embodiment, the timing controller 104 illustrated in FIG. 1 outputs, to the timing generator of the image sensor 102, configuration information about timings when the signal φRAMP_RES is set to the L level from the H level, on the basis of noise cycle information input from the noise detector 109. The timing controller 104 outputs, to the timing generator of the image sensor 102, configuration information specifying that a time when the signal φRAMP_RES is set to the L level from the H level is set to a time T27_{—}1, this signal φRAMP_RES being a signal before AD conversion of the amplified N signal corresponding to the pixel 200 in the m-th (m is a natural number) row.

The timing controller 104 outputs, to the timing generator of the image sensor 102, configuration information specifying that a time when the signal φRAMP_RES is set to the L level from the H level is set to a time T30_{—}1, this signal φRAMP_RES being a signal before AD conversion of the amplified S signal corresponding to the pixel 200 in the m-th (m is a natural number) row.

As a result, the image capturing device of this exemplary embodiment is able to align the phase of the cyclic noise at the time T27_{—}1 in FIG. 9 with the phase of the cyclic noise at the time T30_{—}1 in FIG. 9. Accordingly, the image capturing device of this exemplary embodiment is able to produce to a small degree an offset between the ramp signal VRAMP used in AD conversion of the amplified N signal and the ramp signal VRAMP used in AD conversion of the amplified S signal. As a result, it is possible to easily make the amount of a noise component caused by cyclic noise in a digital signal based on the amplified S signal equal to the amount of a noise component caused by cyclic noise in a digital signal based on the amplified N signal. Therefore, it is possible to reduce a noise component caused by cyclic noise which is included in an image capturing signal obtained by subtracting the digital signal based on the amplified N signal from the digital signal based on the amplified S signal.

In this exemplary embodiment, an example has been described in which timings when the signal φRAMP_RES is set to the L level from the H level are controlled on the basis of the cycle of cyclic noise detected by the noise detector 109. As another example, the driving frequency of the source of cyclic noise may be changed on the basis of the cycle of the cyclic noise detected by the noise detector 109.

Note that any of the embodiments of the present invention is merely an example of embodiment for implementing the present invention, and the technical scope of the present invention should not be restrictively interpreted thereby. That is, the present invention may be implemented in various forms without departing from the technical spirit or major features thereof.

According to the embodiments of the present invention, it is possible to easily make the amount of cyclic noise included in a photoelectric conversion signal equal to the amount of cyclic noise included in a noise signal. As a result, an image sensor is able to output an image capturing signal obtained by subtracting the cyclic noise from the photoelectric conversion signal with high accuracy.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-255672, filed Dec. 11, 2013, which is hereby incorporated by reference herein in its entirety.

What is claimed is:

1. A device comprising:
an image sensor including
a pixel configured to generate a photoelectric conversion signal by performing photoelectric conversion based on an incident light, and
a signal processor configured to sample the photoelectric conversion signal and a noise signal occurring in the pixel;
a detector configured to detect a cycle of cyclic noise produced by an operation of an external circuit; and
a controller configured to set timings when the signal processor samples the photoelectric conversion signal and the noise signal, based on the detected cycle.

2. The device according to claim 1, wherein
one cycle of the cyclic noise has a length T, and
the controller sets a time difference between a timing when the signal processor retains the noise signal and a timing when the signal processor retains the photoelectric conversion signal to a value of n times the length T, n being a natural number.

3. A device comprising:
an image sensor including
a pixel configured to generate a photoelectric conversion signal by performing photoelectric conversion based on an incident light, and
a signal processor configured to sample the photoelectric conversion signal and a noise signal occurring in the pixel;
a detector configured to detect a cycle of cyclic noise produced by an operation of an external circuit; and
a controller configured to control a driving frequency of the external circuit so as to make the detected cycle of the cyclic noise have a length of A/p times a time difference A between a timing when the signal processor retains the noise signal and a timing when the signal processor retains the photoelectric conversion signal, p being a natural number.

4. A device comprising:
an image sensor including
a pixel configured to generate a photoelectric conversion signal by performing photoelectric conversion based on an incident light,
an analog-digital converter configured to perform analog-digital conversion on the photoelectric conversion signal and a noise signal occurring in the pixel, and
a reference signal supply unit configured to supply a first reference signal used in analog-digital conversion on the noise signal and a second reference signal used in analog-digital conversion on the photoelectric conversion signal;
a detector configured to detect a cycle of cyclic noise produced by an operation of an external circuit; and
a controller configured to set a timing when an initial value of the first reference signal is determined and a timing when an initial value of the second reference signal is determined, based on the detected cycle of the cyclic noise.

5. The device according to claim 1, wherein the external circuit is a DC-DC converter that generates a voltage to be supplied to the image sensor.

6. The device according to claim 3, wherein the external circuit is a DC-DC converter that generates a voltage to be supplied to the image sensor.

7. The device according to claim 4, wherein the external circuit is a DC-DC converter that generates a voltage to be supplied to the image sensor.

8. The device according to claim 1, further comprising:
a drive circuit configured to drive an optical system that guides incident light to the image sensor, wherein
the external circuit is the drive circuit.

9. The device according to claim 3, further comprising:
a drive circuit configured to drive an optical system that guides incident light to the image sensor, wherein
the external circuit is the drive circuit.

10. The device according to claim 4, further comprising:
a drive circuit configured to drive an optical system that guides incident light to the image sensor, wherein
the external circuit is the drive circuit.

11. The device according to claim 1, further comprising:
an anti-vibration circuit configured to perform image stabilization by moving the image sensor, wherein
the external circuit is the anti-vibration circuit.

12. The device according to claim 3, further comprising:
an anti-vibration circuit configured to perform image stabilization by moving the image sensor, wherein
the external circuit is the anti-vibration circuit.

13. The device according to claim 4, further comprising:
an anti-vibration circuit configured to perform image stabilization by moving the image sensor, wherein
the external circuit is the anti-vibration circuit.

14. An image sensor comprising:
a pixel configured to generate a photoelectric conversion signal by performing photoelectric conversion based on an incident light;
a signal processor configured to sample the photoelectric conversion signal and a noise signal occurring in the pixel;
a detector configured to detect a cycle of cyclic noise produced by an operation of an external circuit; and
a controller configured to set timings when the signal processor samples the photoelectric conversion signal and the noise signal, based on the detected cycle.

15. A method for driving a device that includes an image sensor, the image sensor including a pixel that generates a photoelectric conversion signal by performing photoelectric conversion based on an incident light and a signal processor that samples the photoelectric conversion signal and a noise signal occurring in the pixel, the method comprising:
detecting a cycle of cyclic noise produced by an operation of an external circuit; and
setting timings when the signal processor samples the photoelectric conversion signal and the noise signal, based on the detected cycle of the cyclic noise.

16. A method for driving an image sensor including a pixel that generates a photoelectric conversion signal by performing photoelectric conversion based on an incident light and a signal processor that samples the photoelectric conversion signal and a noise signal occurring in the pixel, the method comprising:
detecting a cycle of cyclic noise produced by an operation of an external circuit; and
setting timings when the signal processor samples the photoelectric conversion signal and the noise signal, based on the detected cyclic noise.

17. The method according to claim 15, wherein the external circuit is a DC-DC converter that generates a voltage to be supplied to the image sensor.

18. The method according to claim 15, further comprising:
performing image stabilization by moving the image sensor using an anti-vibration circuit, wherein
the external circuit is the anti-vibration circuit.

19. The method according to claim 16, wherein the external circuit is a DC-DC converter that generates a voltage to be supplied to the image sensor.

20. The method according to claim 16, further comprising:
performing image stabilization by moving the image sensor using an anti-vibration circuit, wherein
the external circuit is the anti-vibration circuit.
